(19) United States
(12) Patent Application Publication
(10) Pub. No.: US 2007/0294177 A1
(43) Pub. Date: Dec. 20, 2007

(54) Mobile content publishing system and method

(76) Inventors: William Volk, Encinitas, CA (US); Keith Arem, Encino, CA (US); Sherri Cuono, Aliso Viejo, CA (US)

Correspondence Address: DALINA LAW GROUP, P.C., 7910 IVANHOE AVE. #325, LA JOLLA, CA, 92037, US

(21) Appl. No.: 11/454,763

(22) Filed: Jun. 15, 2006

(51) Int. Cl. G06Q 99/00

(52) U.S. Cl. 705/52

(57) ABSTRACT

A mobile content publishing system and method. Enables creation, edit, upload, distribution and sale of ring tones, ringback tones, text, pictures, video or any other mobile content including music. Enables conversion of file formats depending on the playback device. Billing is performed for the creating user automatically. Users may sell and display content without dealing with the complexities of content formatting or billing. The system may also use a website with m-commerce capabilities that allows multiple consumers to purchase content. Editors such as a mixer may be used in one or more embodiments of the invention to create music or ring tones and ringback tones that are then uploaded to a publishing interface such as an e-commerce market for sale. The market may allow for revenue sharing between the market owner, the creator of the content or any other party involved in the distribution of media content.

### BACKGROUND OF THE INVENTION

1. Field of the Invention

Embodiments of the invention described herein pertain to the field of mobile communications. More particularly, but not by way of limitation, one or more embodiments of the invention enable mobile content creation, publishing, distribution and sales using mobile communication devices.

2. Description of the Related Art

There are a number of requirements and/or preferences associated with the creation, publishing, distribution and sales of media using mobile communication devices. Mobile content is the media that is available for use on a mobile communication device such as a ring tone, ringback tone, wall paper, video, picture or any other type of information that may be displayed or utilized on the mobile communication device.

More and more Internet users are uploading content to show and/or share with other users. Text, photo, and video ‘blogs’ are some popular websites that are used for this purpose. At the same time the mobile content market imposes difficult requirements on the publisher due to the multitude of formats and complex delivery systems required to place content onto mobile handsets and bill users. Existing creation tools allow content to be created by users of the mobile device, for example it is possible to create a ring tone via a the mobile device. However, these existing solutions appear to lack a mechanism that allows users to create and publish content from their own mobile communication device for sale to a variety of mobile handsets without having to handle the formatting and billing complexities associated with such activities.

For at least the reasons set forth above there is a need for a system and method that overcomes the limitations of existing systems and provides a mobile content publishing system and method.

### BRIEF SUMMARY OF THE INVENTION

One or more embodiments of the invention enable a mobile content publishing system and method. Systems implementing one or more aspects of the invention enable the creation, edit, upload, distribution and sale of ring tones, ringback tones, videos, pictures, text, games and other interactive applications or any other content that may be presented on a mobile communications device. One or more embodiments of the invention allow for the conversion of file formats depending on the device that downloads the mobile content. Furthermore, all billing is performed for the user automatically so the user may display and sell content without having to handle the complexities of content formatting or billing. An Interactive Voice Response (IVR) component may be utilized to aid in the generation of content. A mixer such as a web based mixer is used in one or more embodiments of the invention to create ring tones and ringback tones that are then uploaded to a purchasing interface such as an e-commerce market or electronic shopping system. Other content can be edited on the mobile communications device and/or uploaded to the market as well. The market allows consumers to purchase ring tones and ringback tones from the individuals that create and publish the tones or other content. The market is configured to enable revenue sharing between the market owner, the creator of the content or any other party involved in the distribution of the ring tones or ringback tones for example. In one or more embodiments of the invention the market is in the form of a website that utilizes for example online m-commerce capabilities and allows for multiple consumers to purchase content for playback on mobile communication devices. The user may also add services to the mobile communication device using an application employed in one or more embodiments of the invention that runs on the mobile communications device or on a computing element such as a personal computer.

There are a number of different ways the various embodiments of the invention enable the creation of content a few of them are mentioned herein for purposes of example. For instance in one case the system allows the mobile device user to call a specific phone number and in a manner similar to leaving a message, create a digital audio ring tone or ringback tone. The user is identified by the number of the mobile communication device that was used to place the call. Alternatively, the user may simply record the audio locally on the mobile communication device locally before transferring the audio to a server at a specified number, email address or URL for example. In addition, the user can use a mixer component that runs on the mobile communication device for example to mix in audio sampled from musical instruments or other types of sounds such as nature sounds for example. Once the audio is transferred to the server, the user may then preview the ring tone, save the ring tone or record the ring tone again. The audio is converted on the server for preview and into formats utilized by available mobile communication devices.

One or more embodiments of the invention enable mobile devices users to create pictures and upload them for sale. Creation of pictures (i.e., for wallpaper for example) and video may occur using the built in camera on a mobile communication device. The picture or video content is edited on the mobile communication device if the mobile communication device has the requisite computing power and editing application installed. The user uploads the content to the server, at a given phone number, email address or URL for example. The content is then converted into the formats utilized by available mobile communication devices.

The user can also create and publish text, for example a blog. The user may create text directly on the phone or call a particular number that uses voice recognition software to convert the audio stream into text. The user may review and edit the text if desired. Once finalized the text is uploaded and/or saved on the server for publication. In one embodiment of the invention the text is published to a ‘channel’ that consumers subscribe to. The user that created the content may be compensated for the text based on a function of the number of subscribers and the subscription price. In at least one embodiment of the invention users are compensated only on days that they create content. The creation based compensation however is optional and other compensation alternatives are considered within the scope and spirit of the invention.

The system also provides users with a mechanism to create comics or other media types as well. The mobile communication device may be utilized to draw a comic, perform the subtitling and upload of the comic for example. Any other type of media creation and upload is in keeping with the spirit of the invention.

The system may also be used for the creation of games and other interactive applications. For example, an application running on the local device may utilize an application builder to build interactive applications for use on mobile communications devices. The application builder may be utilized to build games and create and mix sounds for the games for example.

The user may supply metadata in addition to the content. For example, the user may provide thumbnail images, audio and video previews to facilitate the sale of the content. Alternatively, the system may generate this metadata based on the uploaded content itself. Other metadata such as a name for the content and/or a brief text description may be obtained from the user using the text input capabilities of the mobile communication device or voice input.

When uploading content, the system may authenticate the user so that unauthorized use of the publish features is denied. Offensive content may be disallowed or cause a user to incur warnings or a ban from use of the system depending on the nature of the offense. Logging of times and content uploaded may be used later for legal or law enforcement purposes. Once a user authenticates, the upload may occur. After upload occurs, then consumers may browse the content and decide to purchase the content. All billing is handled by the system so that the creator of the content does not have to perform billing directly.

### BRIEF DESCRIPTION OF THE DRAWINGS

The above and other aspects, features and advantages of the invention will be more apparent from the following more particular description thereof, presented in conjunction with the following drawings wherein:

FIG. 1 is an architectural view of the system.

FIG. 2 is a flowchart that describes an embodiment of the publication method.

FIG. 3 is an embodiment of a mixer component utilized to create ring tones and ringback tones.

FIG. 4 is an embodiment of an image creation component utilized to create, annotate and edit images.

FIG. 5 is an embodiment of the video editor component that is utilized to edit and upload video content.

FIG. 6 is an embodiment of an image creation component utilized to create, annotate and edit images wherein a clip art image is preselected for use in the generation of media.

### DETAILED DESCRIPTION

A mobile content publishing system and method will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

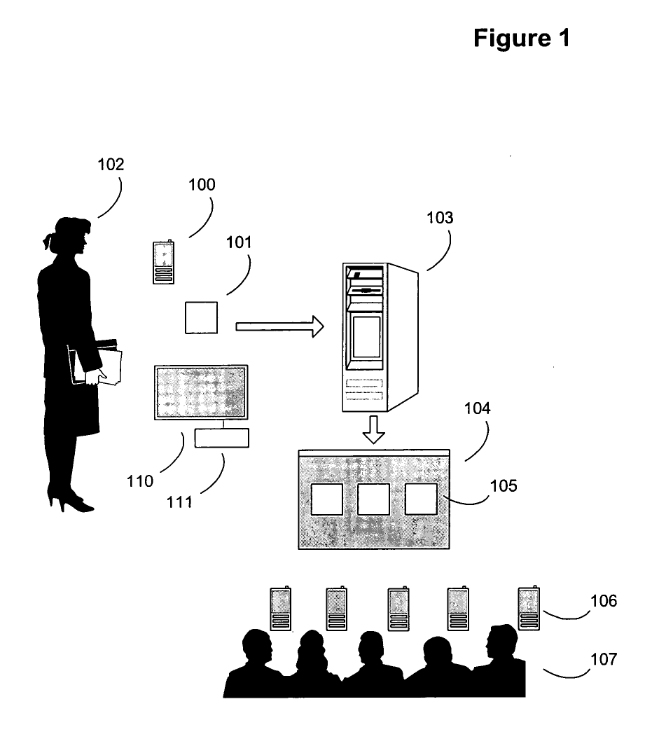

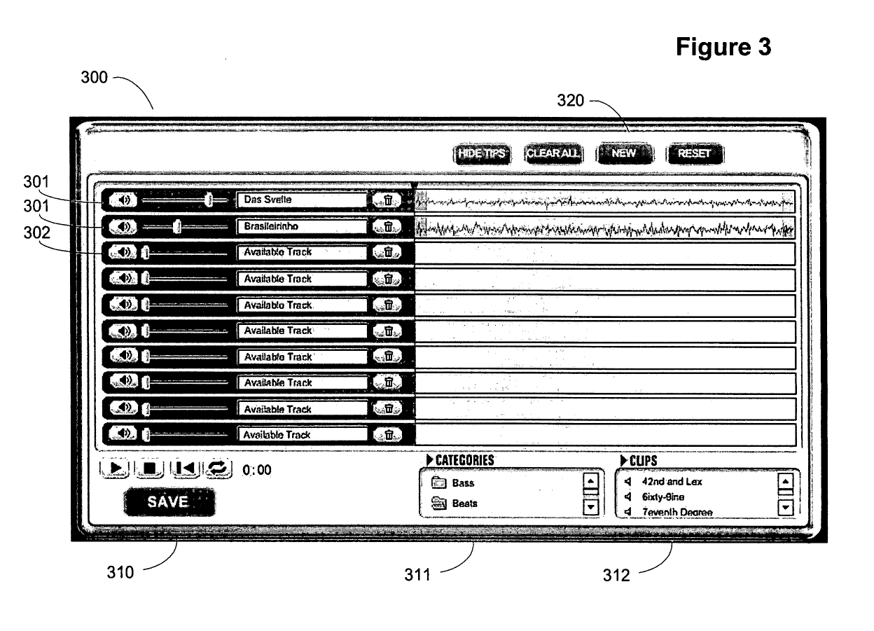

FIG. 1 is an architectural view of an embodiment of the invention. Mobile communication device 100 or monitor 110 are utilized to present content creation, edit and uploading components (see FIGS. 3-5) to user 102. Monitor 110 is coupled with computing element 111, for example a personal computer (PC), a game console or an interactive television (iTV) for example. Any component in the system can have a microphone built-in or couple with a microphone or audio input mechanism. For example, mobile communication device 100 or computing element 111 may use built-in microphones or may allow for microphones to be attached to them. The system enables the creation, edit, upload, distribution and sale of media content 101 (e.g., audio, video, text, etc . . . ) such as ring tones, music, ringback tones, pictures, videos, text or any other content viewable or playable on a mobile communications device. Ringback tones are utilized by a service provider to play an audio file while a person making a call is waiting for the dialed party to answer. Content 101 may be created, edited and uploaded using mobile communication device 100 or computing element 111 coupled with monitor 110. The user may for instance create a custom ring tone, use the device to create music or capture audio or video data. Mobile communication device 100 or computing element 111 may comprise a network component capable of communicating for example to server 103. Communication to server 103 comprise wireless telephone communications or Internet based communications using any communications protocol. One or more embodiments of server 103 allow the conversion of file formats depending on each type of device 107 that downloads the mobile content. Any type of media content capable of playback or viewing on a mobile device is in keeping with the spirit of the invention including for example MMS, SMS, Flash, WAP, XHTML or any other media format or type and files associated with such content. In some cases content is viewed or played through the addition of additional plug-ins or software configured perform such playback or viewing functionality and hence the term content is not limited to functionality embedded in the device but can include functionality added to the device. Content can also include image formats, video formats and other media formats that contain data the mobile device can render or playback. Billing is performed for user 102 on server 103 automatically so that user 102 may sell and display content without having to deal with the complexities of content formatting or billing. The billing system may, for example, process payments for the user and distribute a revenue share based on any payments made. Hence revenue earned from the content may be shared with a merchant who offers the content, the creator of the content and any other party involved in the distribution of the content. Any other third party billing server coupled with server 103 is in keeping with the spirit of the invention. An Interactive Voice Response (IVR) component may be utilized to aid in the generation of content and may be hosted on server 103 or any server coupled with server 103. A web or local application based mixer may be used in one or more embodiments of the invention to create content 105, for example ring tones and ringback tones, using mobile communication device 100 that are uploaded to market 104 (see FIGS. 3-5). Market 104 allows consumers 107 to purchase media such as ring tones, music, ringback tones, videos, text, pictures or other content from the individuals that create and publish content 105. The market may allow for revenue sharing between the market owner, the creator of the content (here user 102) or any other party involved in the distribution of content 105 for example. For instance the market owner and the content creator may proportionally share in the revenue earned from sale of the content created by the content creator. The market may be in the form of a web page or may use a text messaging short-code for example. Any method for presenting content descriptors and content to a consumer is in keeping with the spirit of the invention. The system may include an image editing and upload tool, a video upload tool and a text tool host for example on mobile communication device 100. Any editing application for example may reside on mobile communication device 100 or may be downloaded to mobile communication device 100 or may be accessed over a URL for example. Market 104 may be in the form of a website that may utilize for example online m-commerce capabilities and allow multiple consumers 107 to purchase content that may be played back on mobile communication devices 106.

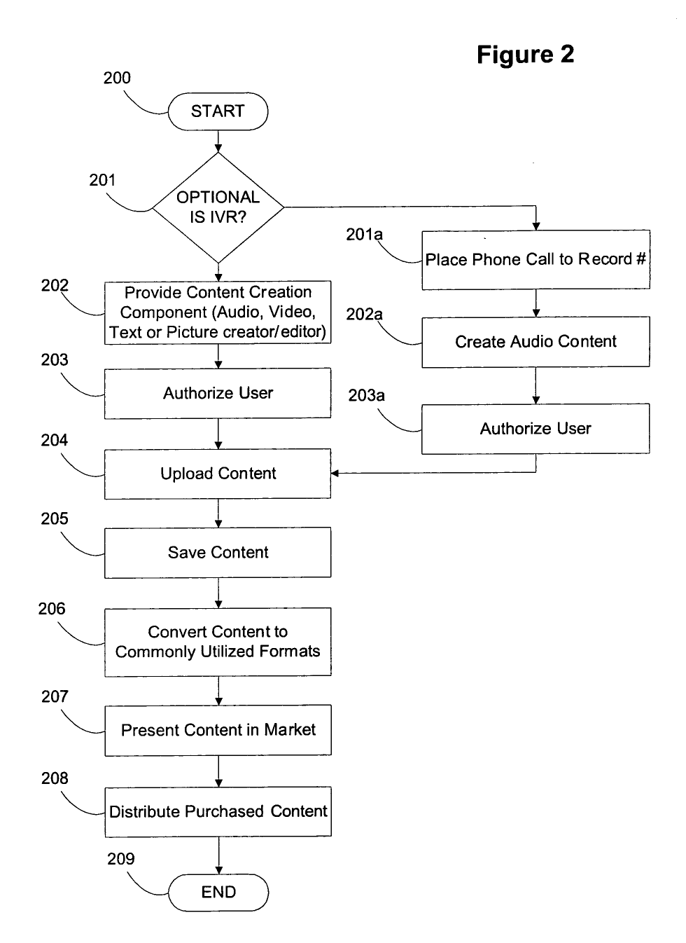

FIG. 2 is a flowchart that describes the publication method used by one or more embodiments of the invention. Creation of content starts at 200 and may take place in a number of ways. In embodiments where IVR recording of audio is utilized, the optional check “Is IVR” is utilized at 201 to determine whether to utilize recording of the audio over the communications link. In other embodiments of the invention where IVR is not utilized, this optional step 201 may or may not be performed. If the IVR check is not performed, or if the IVR check is performed and the user decides to locally create content, the system may provide a content creation component (see FIGS. 3-5) or utilize the built-in components of the mobile communication device to allow for the creation of content at 202. The system authenticates the user at 203. This may entail entering a password or use of a voice recognition system to authorize a particular user. Any other method of authorizing the user is in keeping with the spirit of the invention including use of biometric fingerprint readers or eye scanners for example built into the mobile communication device. Before uploading content, the system may authenticate the user so that unauthorized use of the publish features is denied. In one embodiment of the invention offensive content is disallowed or causes the user to incur warnings or be banned from use of the system depending on the nature of the offense. Logging of times and content uploaded can be used later for legal or law enforcement purposes. In one or more embodiments of the invention, a team of workers reviews content before it is allowed to be sold via the system. Optionally, filters for copyrighted music and photos may reject content as copyrighted material that cannot be resold. After authenticating the user, the system then uploads the content to a market running on a server such as an m-commerce website for example at 204. In the case of an IVR embodiment, the user may record the audio locally on the mobile communication device at 202 before transferring the audio to a server at a specified number, email address or URL for example at 204. Once the content is transferred to the server, the user may preview the content, e.g., ring tone, ringback tone, video, text or picture using the mobile communication device or an external website for example. The system provides the user with a save option and if the user selects save, the system saves the content at 205. The content is converted on the server into formats utilized by available mobile communication devices at 206. In one or more embodiments of the invention, the content is converted “on-the-fly”, meaning that it is not saved since there may be 100 different screen resolutions for example that content may need to display on. In other embodiments of the invention, content is cached in total. The system may also cache the most frequently utilized content types. The content is then presented to the market at 207. At this point, consumers can purchase the content or the user may receive payments for subscribers to the content and the system distributes the content to the consumers at 208. The mobile communication device is generally checked to make sure that the person the content is to be delivered to was the person who purchased the content. This prevents people from purchasing content for a phone they do not own, which may include offensive or undesired content. In the case of IVR recording of audio, the system allows the user to call a specific phone number for recording audio at 201a. The system creates an audio recording such as a digital audio ring tone or ringback tone at 202a based on the sounds entered by the user. The user is identified by the number of the mobile communication device that was used to place the call and may be authorized by entering a password on the keypad of the mobile communication device or by speaking into the mobile communications device so that voice recognition software may authenticate the particular user at 203a. Processing continues at 204 where upload is performed by the system as described above. Processing ends at 209.

FIG. 3 is an embodiment of a mixer component utilized to create ring tones and ringback tones. The user can use mixer component 300 running on the mobile communication device for example to mix in audio sampled from musical instruments or other types of sounds such as nature sounds for example. Audio samples 301, 302 and 303 are shown as a snare drum, clapping and second drum for example. Audio samples 301, 302 and 303 are shown vertically descending on the screen with audio amplitude versus time graphs to the right of each sample name. When the desired combination of samples is mixed together with appropriate amplitudes as set by the sliders to the right of each sample's name, the audio may then be saved using save button 310. The audio may be played, rewound, and played as a continuous loop using the buttons found immediately above save button 310 and below the list of audio samples. Categories for audio clips to add are shown in category list 311. When a category is selected in category list 311, the audio clips in the category are shown in clip list 312. Button block 320 allows the clips to be acted upon for creating a new clip, resetting a clip or all clips, showing tips or help for example. One of the tracks of mixer component 300 may control the vibration device of mobile communication device 100, so that for example a song with a beat may shake the mobile communication device with the beat of the track.

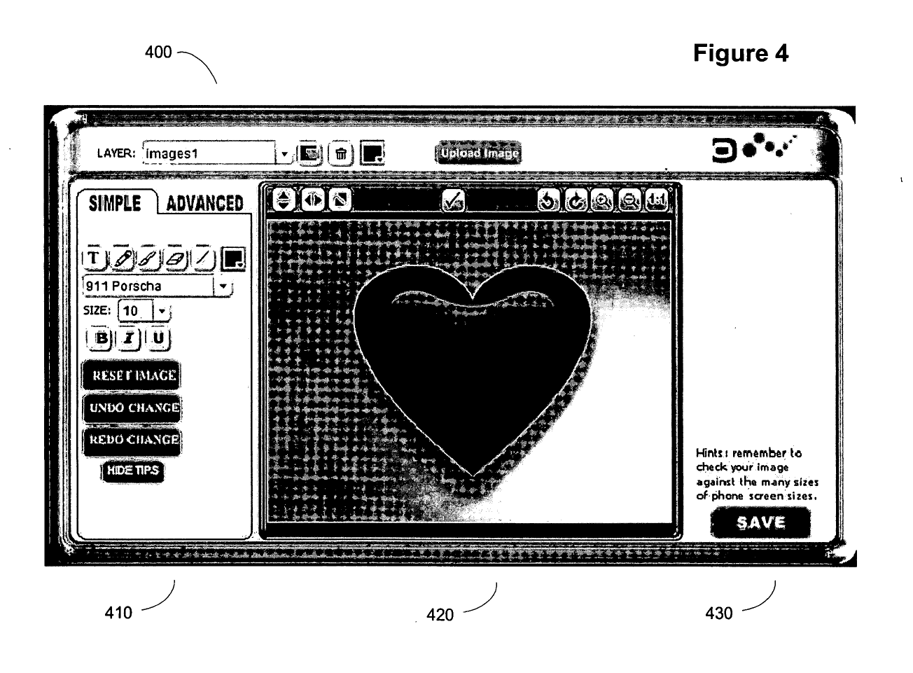

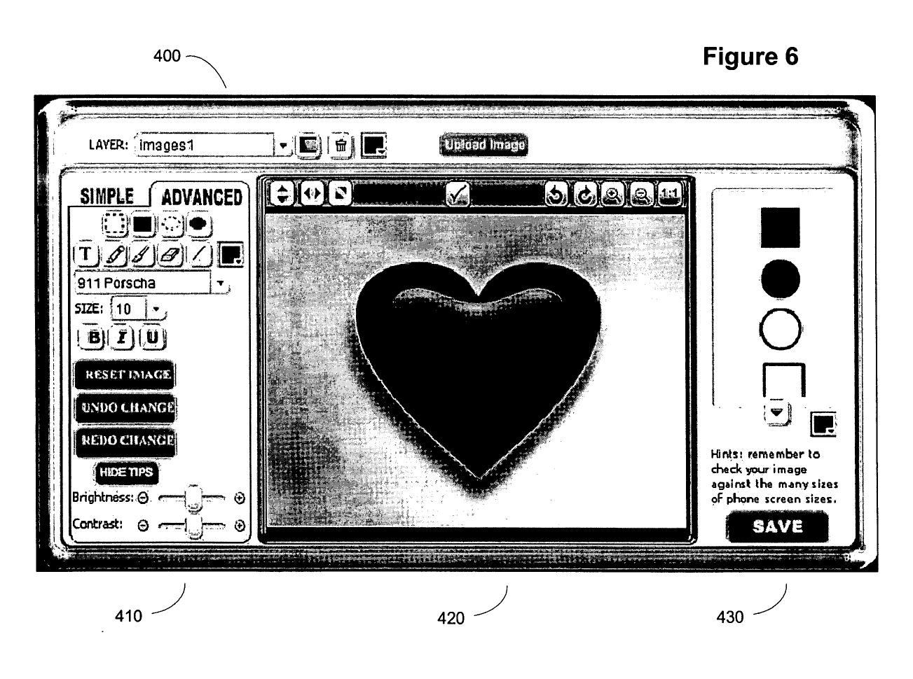

FIGS. 4 and 6 show an embodiment of an image creation and edit component utilized to create, annotate and edit images. (FIG. 4 and 6 differ by the content displayed). Image editor 400 allows for simple or complex editing of images. The image shown in image frame 420 for example may be annotated using image editing components shown in area 410. The image editing components allow for the drawing of shapes with any color and the drawing of text in any font, size and color and the drawing of freehand lines with any color or thickness for example. Image Creation of pictures (i.e., for wallpaper for example) and video may occur using the built in camera on a mobile communication device. Once the picture or video is obtained, then image editor 400 may be utilized to annotate the picture or a single frame of the video for example. The user may save the image using save button 430 after editing and then upload the content to the server, at a given phone number, email address or URL for example. The content is then converted on the server into the formats utilized by available mobile communication devices. FIG. 6 shows a clip art image that is used as the basis for generating media wherein the clip art is selected from area 430 on the right side of the graphical user interface.

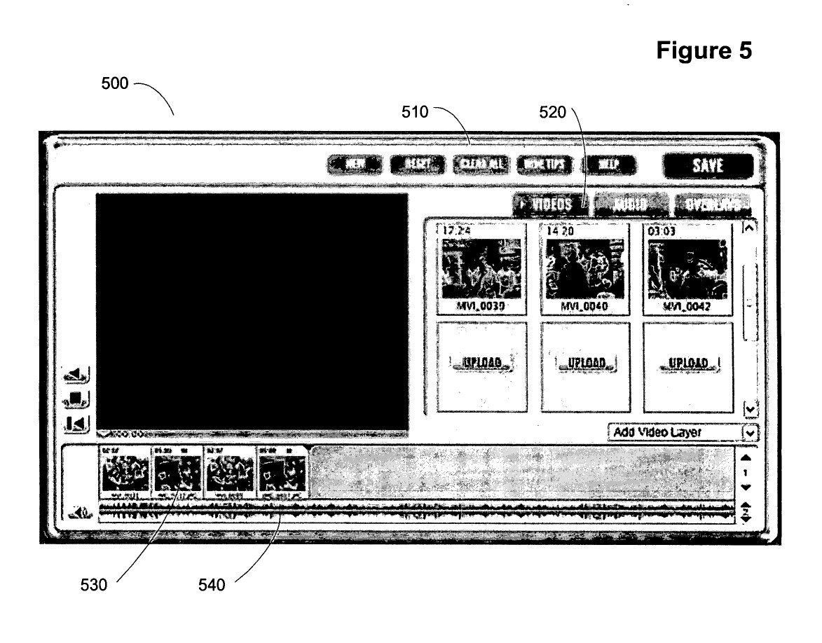

The user can also create and publish text, for example a blog. Text may be created directly on the phone or the user may call a particular number that uses voice recognition software to convert the audio stream into text. Alternatively, image editor 400 may be utilized without an image in order to provide this functionality for example. The user may then review the text and edit the text if desired. The text may then be uploaded and/or saved on the server for publication. The text may be published to a ‘channel’ that consumers subscribe to. The user that has created the content may then for example be compensated for the text based on a function of the number of subscribers and the subscription price. The users may optionally only be compensated on days that they create content. The system may pay a content creator via PayPal® for example. The system may also be used for the creation of comics or other media types as well. The mobile communication device may be utilized to draw a comic, perform the subtitling and upload of the comic for example. Any other type of media creation and upload is in keeping with the spirit of the invention. FIG. 5 is an embodiment of the video editor component that is utilized to edit and upload video content. Video content editor 500 shows video list 520 under buttons 510. Buttons 510 are utilized in creating new video clips, clearing the clips that make up a video and for help functions. To the right of buttons 510 is the Save button. Video list 520 also shows upload buttons beneath each video to allow for the upload of the videos. The edited video is shown at the bottom of video content editor 500 as video thumbnails 530. The combined audio that may be created separately for example using mixer component 300 as shown in FIG. 3, is shown as amplitude versus time graph 540. When the user uploads content, the user may supply metadata in addition to the content. For example, the user may provide thumbnail images, audio and video previews to facilitate the sale of the content. Alternatively, the system may generate this metadata based on the uploaded content itself. Other metadata such as a name for the content and/or a brief text description may be obtained from the user using the text input capabilities of the mobile communication device or voice input.

The system may also be used for the creation of games and other interactive applications. For example, an application running on the local device may utilize an application builder to build interactive applications for use on mobile communications devices. The application builder may be utilized to build games and create and mix sounds for the games for example. In one embodiment, the user may program art or clip art to move and interact in desired ways using a scripting language or other automated application environment. In one or more embodiments, the user may program interaction via a series of menus for example in the form of a wizard. Any method of programming interactive functionality that may be uploaded and sold by a user is in keeping with the spirit of the invention.

While the invention herein disclosed has been described by means of specific embodiments and applications thereof, numerous modifications and variations could be made thereto by those skilled in the art without departing from the scope of the invention set forth in the claims.

What is claimed is:

1. A mobile content publishing system comprising:
a mobile communication device comprising a display region, said mobile communication device being configured to create, edit and upload content when directed by a user;
a server coupled with said mobile communication device over a communication network wherein said server is configured to convert said content into a plurality of file formats for presentation on a plurality of mobile communication devices that each use a different file format for content and wherein said server is further configured to authenticate said user before allowing said user to upload said content;
a purchasing interface hosted on said server;
said purchasing interface configured to present said content created by said mobile communication device to said plurality of mobile communication devices associated with consumers; and,
said server configured to bill said consumers for said content wherein said users purchase said content.

2. The mobile content publishing system of claim 1 further comprising:
an IVR component configured to record said content.

3. The mobile content publishing system of claim 1 further comprising:
an audio mixer component configured to run on said mobile communication device.

4. The mobile content publishing system of claim 1 further comprising:
a video editor configured to run on said mobile communication device.

5. The mobile content publishing system of claim 1 further comprising:
an image editor configured to run on said mobile communication device.

6. The mobile content publishing system of claim 1 wherein said content comprises a ring tone.

7. The mobile content publishing system of claim 1 wherein said content comprises a ringback tone.

8. The mobile content publishing system of claim 1 wherein said content comprises audio data.

9. The mobile content publishing system of claim 8 wherein said audio data comprises music.

10. The mobile content publishing system of claim 1 wherein said content comprises a video.

11. The mobile content publishing system of claim 1 wherein said content comprises an image.

12. The mobile content publishing system of claim 1 wherein said content comprises text.

13. The mobile content publishing system of claim 1 wherein said purchasing interface is coupled to a billing system configured to process payments for said user and distribute a revenue share based on said payment.

14. A method for mobile content publishing comprising:
providing a content editor to a mobile communication device wherein said content editor is configured to create, edit and upload content when directed by a user;
converting said content on a server into a plurality of file formats for presentation on a plurality of mobile communication devices that each use a different file format for content;
authenticating said user before allowing said user to upload said content;
uploading said content to a purchasing interface hosted on said server;
presenting said content on said purchasing interface to said plurality of mobile communication devices associated with consumers; and,
billing said consumers for said content when said users purchase said content.

15. The method of mobile content publishing of claim 14 further comprising:
providing an IVR component configured to record said content.

16. The method of mobile content publishing of claim 14 further comprising:
presenting an audio mixer component on said mobile communication device.

17. The method of mobile content publishing of claim 14 further comprising:
presenting a video editor on said mobile communication device.

18. The method of mobile content publishing of claim 14 further comprising:
presenting an image editor on said mobile communication device.

19. The method of mobile content publishing of claim 14 wherein said content comprises a ring tone.

20. The method of mobile content publishing of claim 14 wherein said content comprises a ringback tone or a video or an image or text.
